(19) United States
(12) Patent Application Publication
(10) Pub. No.: US 2019/0020143 A1
(43) Pub. Date: Jan. 17, 2019

(54) POKE-IN CONNECTOR

(71) Applicant: Molex, LLC, Lisle, IL (US)

(72) Inventors: Jang Bum JIN, Ansan (KR); Ji-Su SHIN, Ansan (KR); Sa-cheol HONG, Ansan (KR)

(73) Assignee: Molex, LLC, Lisle, IL (US)

(21) Appl. No.: 16/032,299

(22) Filed: Jul. 11, 2018

(30) Foreign Application Priority Data
Jul. 12, 2017 (KR) 10-2017-0088523

(51) Int. Cl. H01R 13/428; H01R 12/57; H01R 13/11; H01R 4/48

(52) U.S. Cl. CPC H01R 13/428; H01R 12/57; H01R 12/7076; H01R 4/4818; H01R 13/111

(57) ABSTRACT

The present disclosure relates to a poke-in connector of a single plate structure which is stably mounted on a substrate and is not provided with a separate molding portion. The poke-in connector has a wire connection space formed therein by bending a plate of a sheet shape in a container shape, and has a wire insertion port formed at a front thereof, and includes: a mounting plate mounted on a substrate; a first support plate bending upward from an end of the mounting plate; a pickup plate bending from an end of the first support plate to face the mounting plate; a second support plate bending from an end of the pickup plate to face the first support plate, and having an end mounted on the substrate; and connection plates bending from rear ends of the first support plate and the second support plate toward the wire insertion space, and connecting a wire inserted into the wire connection space.

### RELATED APPLICATIONS

This application claims priority to Korean Application No. 10-2017-0088523, filed Jul. 12, 2017, which is incorporated herein by reference in its entirety.

### TECHNICAL FIELD

The present disclosure relates to a wire to board connector, and more particularly, to a wire to board poke-in connector of a single plate structure, which can be stably mounted on a substrate and is not provided with a separate molding portion.

### BACKGROUND ART

In general, a wire to board connector refers to a connector that is used to connect a wire of an electric/electronic device and a printed circuit board with each other. One of the connectors that brings a wire into contact with a terminal and locks the wire into the terminal simply by inserting the wire into the terminal is referred to as a poke-in connector.

A related-art general poke-in connector has a structure in which a molding portion is coupled to a contact terminal mounted on a substrate while surrounding the contact terminal, the contact terminal and a wire insertion port of the molding portion are arranged in the same direction, and a wire is inserted in a horizontal direction through the wire insertion port, and is connected to the contact terminal. The molding portion guides the insertion of the wire and prevents unnecessary interference between the wire and the contact terminal, and stably maintains mounting of the contact terminal, thereby enhancing reliability of electrical contact.

As electric devices are miniaturized in recent years, sizes of substrates on which connectors are mounted are getting smaller. However, the related-art connector having the molding portion coupled to the contact terminal is an impediment to miniaturization of the substrate and the electric device because the molding portion occupies relatively large area and space on the substrate. As a solution to this problem, U.S. Pat. No. 8,721,376B1 introduces a poke-in connector of a signal plate structure, which is formed of only a contact terminal, with the title “SINGLE ELEMENT WIRE TO BARD CONNECTOR.”

FIG. 1 is a perspective view showing a related-art connector, that is, the poke-in connector of the prior art document, and FIG. 2 is a cross-sectional view in I-I direction showing a wire insertion structure for the connector of FIG. 1.

Referring to FIG. 1, the connector 10 of the prior art document is formed of a single plate, and includes a mounting plate 11 soldered to a substrate 20, one pair of support plates 13 having a wire insertion port 12 formed at a front portion thereof, and bending upward from both sides of the mounting plate 11, and a pickup plate 15 which bends when the support plate 13 on one side shields an upper portion of the wire insertion port 12. Herein, the mounting plate 11 provides a blocking wall 16 formed by bending upward the opposite end of the wire insertion port 11 to block the insertion of a wire 30, and the one pair of support plates 13 facing each other provide locking terminals 14, respectively, having insertion direction ends bending inward.

The connector of the prior art document is formed of the single plate structure without a molding portion, and thus may be easily mounted on a substrate of a small size, and has the advantage of contributing to miniaturization of electric devices.

However, in the related-art connector, the one pair of support plates 13 are coupled to each other by the mounting plate 11 on the lower side, but are physically separated between the pickup plate 15 and the support plate 13 on the other side on the upper side. Accordingly, when the wire 30 is repeatedly connected and pulled out between the one pair of locking terminals 14, the one pair of support plates 13 and the one pair of locking terminals 14 easily suffer from plastic deformation, and thus there is a disadvantage that reliability and durability of contact are degraded.

In addition, in the related-art connector 10, the mounting plate 11, the one pair of support plates 13, and a front end of the pickup plate 15 provide the wire insertion port 12 on the same plane in the vertical direction. In general, in a poke-in connector in a horizontal connection direction, the wire 30 is inserted into the connector 10 in a direction of being tilted slightly. Accordingly, the related-art connector 10 has a disadvantage that a sheath 31 surrounding the wire 30 collides or interferes with an end of the pickup plate 15 on the upper side during the wire insertion process as shown in FIG. 2, and it is difficult to connect the wire. In order to prevent collision or interference between the connector 10 and the wire sheath 31 as described above, the wire 30 should be inserted only at a horizontal tilt angle θ1 of about 8° or less.

Patent Document 1: U.S. Pat. No. 8,721,376 B1

### SUMMARY

The present disclosure has been suggested to solve the above-mentioned problems, and an object of the present disclosure is to provide a wire to board poke-in connector of a single plate structure, which removes a molding portion of the connector and is advantageous to miniaturization of electric devices, and can enhance reliability of connection.

To achieve the above-described object, the poke-in connector of the present disclosure has a wire connection space formed therein by bending a plate of a sheet shape in a container shape, and has a wire insertion port formed at a front thereof. The poke-in connector includes: a mounting plate mounted on a substrate; a first support plate bending upward from an end of the mounting plate; a pickup plate bending from an end of the first support plate to face the mounting plate; a second support plate bending from an end of the pickup plate to face the first support plate, and having an end mounted on the substrate; and connection plates bending from rear ends of the first support plate and the second support plate toward the wire insertion space, and connecting a wire inserted into the wire connection space.

In addition, the second support plate may have a mounting terminal bending from an end thereof toward the mounting plate, and the mounting terminal may be mounted on the substrate.

In addition, the wire insertion port may have an avoidance recess, such that an end of the pickup plate is further stepped back than an end of the mounting plate.

The connection plates may have a two-step bending structure including elastic portions bending from rear ends of the first support plate and the second support plate, and locking portions bending from ends of the elastic portions.

In addition, the poke-in connector of the present disclosure may further include a blocking plate bending upward from a rear end of the mounting plate to block excessive insertion of the wire.

The poke-in connector of the present disclosure is formed by bending a plate of a sheet shape of a single structure in a container shape, and mounting both ends on a substrate. Therefore, the poke-in connector can enhance a coupling force with the substrate, and can be advantageously applied to a substrate or an electric device which is made smaller.

### BRIEF DESCRIPTION OF THE DRAWINGS

FIG. 1 is a perspective view showing a related-art connector;

FIG. 2 is a cross-sectional view showing a wire insertion structure for the connector of FIG. 1;

FIG. 3 is a perspective view showing an example of a connector being mounted on a substrate according to an exemplary embodiment of the present disclosure;

FIG. 4 is a perspective view showing the connector according to an exemplary embodiment of the present disclosure;

FIG. 5 is a top view showing the connector of FIG. 4;

FIG. 6 is a perspective view of the connector of FIG. 4 as viewed from a wire insertion port;

FIG. 7 is a front view showing a wire insertion structure for the connector of the present disclosure;

FIG. 8 is a front view showing a wire bending structure for the connector of the present disclosure;

FIG. 9 is a perspective view showing an unlocking structure for the connector of the present disclosure; and

FIG. 10 is a perspective view showing a connector according to another exemplary embodiment of the present disclosure;

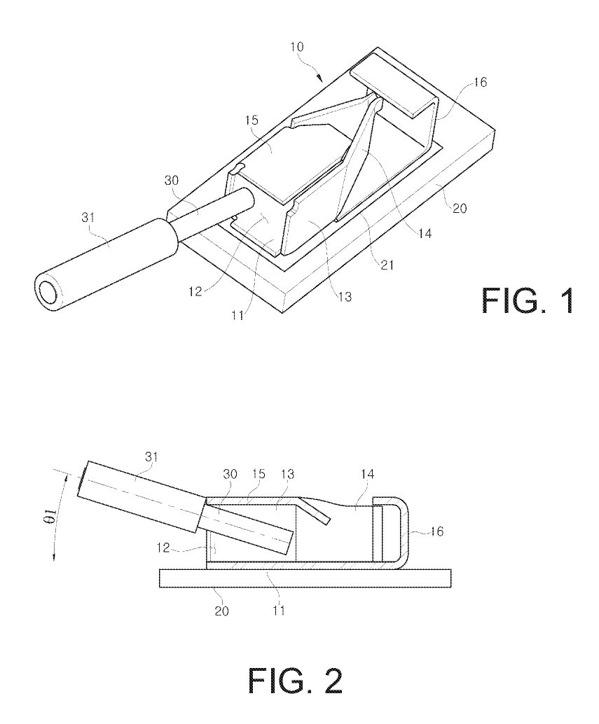

### DETAILED DESCRIPTION OF THE PREFERRED EMBODIMENTS

The present disclosure and the technical objects achieved by embodiments of the present disclosure will be more apparent by preferred embodiments of the present disclosure which will be described below. Hereinafter, preferred embodiments of the present disclosure will be described in detail with reference to the accompanying drawings. In the description of the present disclosure, expressions “front,” “rear,” “upper,” “lower,” “left,” “right,” “first,” and “second” are expressions according to relative locations or directions, and the configuration of the invention is not limited by their dictionary definitions.

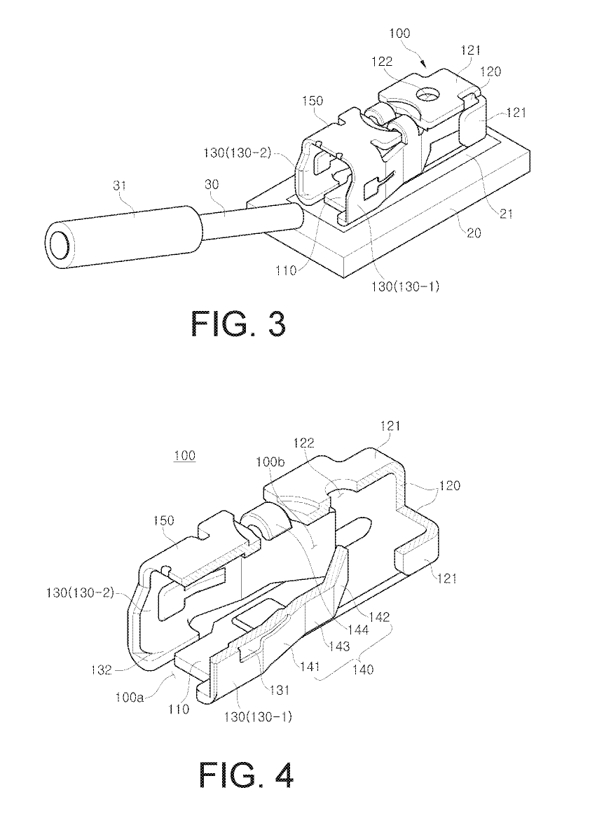

FIG. 3 is a perspective view showing an example of a connector being mounted on a substrate according to an exemplary embodiment of the present disclosure. As shown in the drawing, the connector 100 according to an embodiment of the present disclosure accommodates a wire 30 while being mounted on a substrate 20, and electrically connects the wire 30 and the substrate 20, and is mounted on the substrate 20 without a separate molding portion.

The connector 100 is formed in a container shape by bending a plate of a sheet shape, processed into a predetermined shape by extruding, at a predetermined location, and provides a wire insertion port 100a having one side opened. The substrate 20 may have various elements mounted therein for driving an electric device, and may have circuits printed on a surface thereof to electrically connect the elements, and in particular, may have a mounting pad 21 to allow the connector 100 to be mounted thereon. The wire 30 is exposed to the outside of an insulation sheath 31 by a predetermined length, and is inserted into the connector 100.

The connector 100 is mounted on the mounting pad 21 of the substrate 20 by a process such as soldering, etc., and the wire 30 is inserted through the wire insertion port 100a and then is locked, such that an electrical connection between the substrate 20 and the wire 30 is achieved.

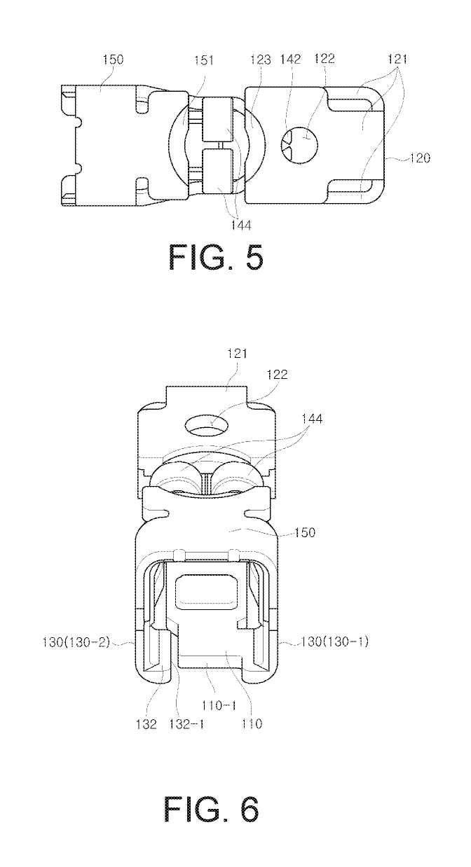

FIG. 4 is a perspective view showing the connector according to an exemplary embodiment of the present disclosure, and specifically, is a partial cutaway perspective view showing an interior structure, FIG. 5 is a top view showing the connector of FIG. 4, and FIG. 6 is a perspective view of the connector of FIG. 4 as viewed from the wire insertion port.

Referring to FIG. 4, the connector 100 of the present disclosure is formed by extruding and bending a conductive metal plate, and includes a mounting plate 110 fixed to the substrate 20, one pair of support plates 130 formed on both side portions of the mounting plate in a vertical direction, and a pickup plate 150 connecting upper ends of the one pair of support plates to each other. The connector 100 of the above-described configuration accommodates the wire 30 in a wire connection space 100b formed among the mounting plate 110, the one pair of support plates 130, and the pickup plate 150. Herein, a direction in which the insertion of the wire starts is referred to as a front, and a direction in which the insertion of the wire ends is referred to as a rear.

The connector 100 of the above-described configuration is a plate of a sheet shape of a single structure, and the plate of the sheet shape continuously forms the mounting plate 110 formed in the horizontal direction in parallel with a surface of the substrate 20, a first support plate 130-1 bending upward from one side end (for example, a right side end on the drawing) of the mounting plate 110, the pickup plate 150 bending from an upper end of the first support plate 130-1 in the horizontal direction to face the mounting plate 110, and a second support plate 130-2 bending downward from the other side end (for example, a left side end on the drawing) of the pickup plate 150 to face the first support plate 130-1. Accordingly, the connector 100 of the present disclosure is formed in a rectangular container shape by bending the plate of the sheet shape, and provides the wire connection space 100b therein, in which connection and locking of the wire 30 are achieved, and provides the wire insertion port 100a formed at the front of the wire connection space 100b to allow the wire 30 to be inserted therethrough.

Specifically, the mounting plate 110 has a lower surface mounted on the mounting pad 21 of the substrate 20, and is electrically connected therewith, and simultaneously, allows the connector 110 to be stably coupled to the substrate 20. The mounting plate 110 may be coupled to the mounting pad 21 by soldering, and soldering is performed along an edge of the plate of the sheet shape, thereby stably maintaining coupling with the substrate 20.

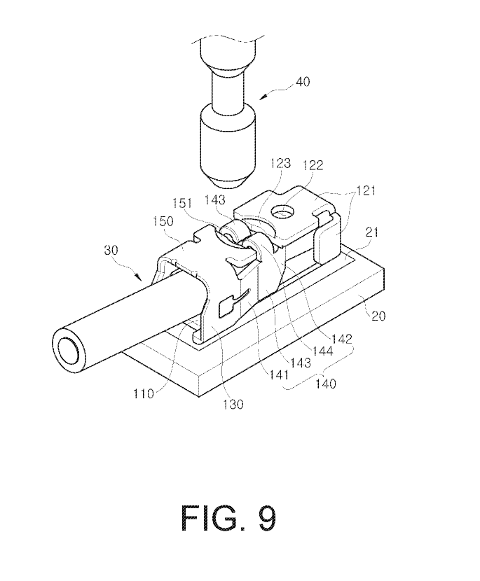

In addition, the mounting plate 110 has a blocking plate 120 formed by bending upward an end of the rear thereof to prevent excessive insertion of the wire 30, and has a shielding wall 121 formed by bending and protruding from an upper end and left and right ends of the blocking plate 120 toward the front to shield the wire connection space 100b. The shielding wall 121 may have a penetrating hole 122 formed thereon to check a state in which a locking portion 142 and the wire 30 are connected with each other in the wire connection space 100b, as shown in FIG. 5, and the penetrating hole 122 may be formed on the upper shielding wall 121. In addition, the upper shielding wall 122 has a stopper surface 123 extended toward the front to prevent excessive insertion of a release tool 40 (see FIG. 9), which will be described below.

The support plates 130 are formed of one pair of plates, including the first support plate 130-1 bending upward from the right side end of the mounting plate 110 in a substantially vertical direction, and the second support plate 130-2 bending downward from the left side end of the pickup plate 150 in a substantially vertical direction, and the first support plate 130-1 and the second support plate 130-2 faces each other to form a symmetrical structure. Each of the support plates 130 has a connection plate 140 formed at the rear end thereof and bending toward the wire connection space 100b inside by a predetermined tilt angle. The one pair of connection plates 140 are separated from the mounting plate 110 and the pickup plate 150, and have elasticity with reference to an axis of the support plate 130, and guide the insertion of the wire 30, are electrically connected with the wire 30, and simultaneously, locks the wire 30 to prevent the wire 30 from being released.

Each of the connection plates 140 includes an elastic portion 141 bending from an end of the support plate 130 firstly, and a locking portion 142 bending from an end of the elastic portion 141 secondarily. A coupling portion 143 is further interposed between the elastic portion 141 and the locking portion 142 in parallel with the support plate 130, thereby coupling the elastic portion 141 and the locking portion 142 to each other. Accordingly, each of the connection plates 140 forms at least two-step bending structure, and the connection plate of the two-step bending structure elastically presses the wire 30 on the locking portion 142 of the end with a stronger force in comparison to a one-step bending structure, and is more resistant even to plastic deformation.

TABLE 1

| | | |
|---|---|---|
| Type | Two-step bending | One-step bending |

| | |
|---|---|
| Push (mm) | 0.3 |

| | | |
|---|---|---|
| Force (N) | 6.012 | 3.975 |
| Plasticity (mm) | 0.011 | 0.078 |

As shown in table 1 above, when the end of the locking portion is pushed to have deformation toward one side by a width of 0.3 mm on the assumption that the wire is inserted, deformation is achieved by a force of 3.975 N in the one-step bending structure, but in the two-step bending structure, the deformation by the same width is achieved only when a force of 6.012 N is applied. Therefore, it can be seen that the locking portion 142 of the connection plate 140 of the two-step bending structure shows a relatively larger pressure.

In addition, plastic deformation of the locking portion according to a restoring state after a push is applied is as follows. The one-step bending structure shows plastic deformation of 0.078 mm, but the two-step bending structure shows plastic deformation of 0.011 mm. Therefore, the locking portion 142 of the connection plate 140 of the two-step bending structure shows an excellent property even in response to plastic deformation.

In addition, each of the connection plates 140 includes an unlocking portion 144 bending inward from an upper end of the coupling portion 143 in an inverted-U shape (‘∩’). The one pair of unlocking portions 144 has a predetermined gap therebetween and curve inward to correspond to each other. When the release tool 40 is inserted between the unlocking portions 144, the one pair of connection plates 140 are spaced apart from each other, such that the wire 30 can be easily pulled out from the connection plates 140.

In addition, each of the support plates 130 may have a concavo-convex portion 131 formed on a side surface thereof coupled to the connection plate 140. The concavo-convex portion 131 is concavely recessed or convexly protrudes on the surface of the plate where the support plate 130 and the connection plate 140 are coupled to each other, and adds a tolerance to elastic deformation of the connection plate 140 made with reference to the axis of the end of the support plate 130, such that the connection plate 140 has a stronger elastic pressure.

The pickup plate 150 bends inward from the upper end of the first support plate 130-1 in a substantially horizontal direction. The pickup plate 150 faces the mounting plate 110 in parallel, and provides a pickup surface formed on an upper surface thereof to allow the connector 100 to be adsorbed onto a mounting tool. In addition, the pickup plate 150 has a stopper surface 151 protruding and extending from an end of the rear thereof to prevent excessive insertion of the release tool 40.

Referring to FIG. 6, the second support plate 130-2 bends from the left side end of the pickup plate 150, and faces the first support plate 130-1 in parallel, and has a mounting terminal 132 bending inward from a lower end thereof. To achieve this, the mounting plate 110 provides a space to avoid the mounting terminal 132. The mounting plate 110 and the mounting terminal 132 form the same plane with a predetermined gap therebetween, and are soldered along their respective edges 110-1, 132-1 and are mounted on the mounting pad 21. Accordingly, the connector 100 of the present disclosure forms a sealing structure by being formed by bending the plate of the sheet shape in the container shape, and mounting both side ends on the substrate 20. Therefore, even when the wire 30 is repeatedly connected or pulled out, plastic deformation does not almost appear and reliability and durability of contact can be enhanced.

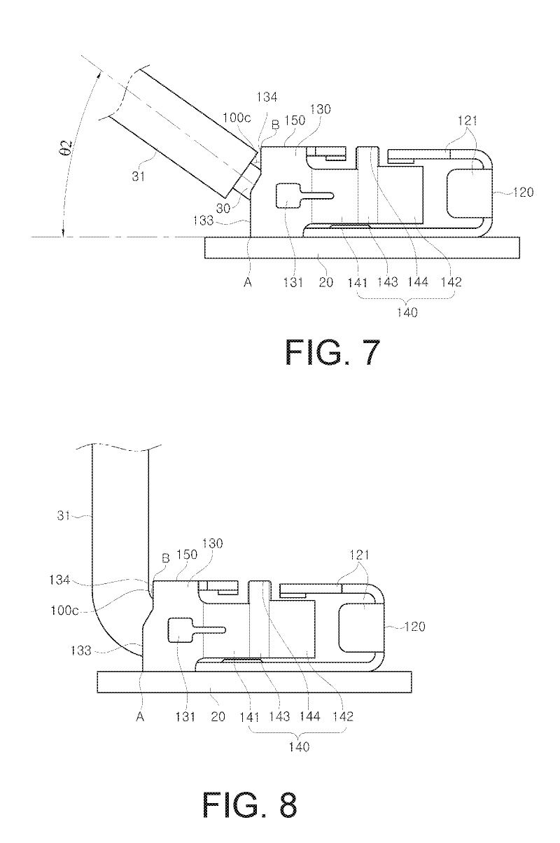

FIG. 7 is a front view showing a wire insertion structure for the connector of the present disclosure, and FIG. 8 is a front view showing a wire bending structure for the connector of the present disclosure.

In the connector 100 of the present disclosure, the mounting plate 110 on the lower side, the one pair of support plates 130 on both sides, and the pickup plate 150 on the upper side form the container shape, and have the wire insertion port 100a formed at the front in a substantial rectangular shape and opened to the front. In this case, as shown in FIGS. 7 and 8, an avoidance recess 100c is formed on the wire insertion port 100a, such that an end B of the pickup plate 150 is further stepped back than an end B of the mounting plate 110. The avoidance recess 100c may be formed by giving a slope to an end of the support plate 130 coupling the end A of the mounting plate 110 and the end B of the pickup plate 150, or by positioning a second vertical end 134 on the upper side further back than a first vertical end 133 on the lower side, and aligning the end B of the pickup plate 150 with an upper end of the support plate 130.

The avoidance recess 100c prevents the wire sheath 31 from colliding or interfering with the upper end of the connector 100 (that is, an end of the pickup plate) when the wire 30 is inserted in a tilt direction as shown in FIG. 7. Accordingly, the avoidance recess 100c increases a tilt angle θ2 of the wire 30 being inserted with respect to the horizontal direction, thereby making it easy to connect the wire 30.

In addition, as shown in FIG. 8, the wire 30 is assembled with an electric device in a state in which the wire 30 is connected to the connector 100 and is bent upward by about 90°. In this case, the wire sheath 31 may collide and interfere with the end B of the pickup plate 150, and the end of the pickup plate 150 is subject to an upward external force by the collision or interference, and the upward external force may be transmitted to the mounting plate 110 and the mounting terminal 132 on the lower surface, and may damage soldering to the substrate 20 or may attenuate a coupling force between the connector 100 and the substrate 20. Accordingly, the avoidance recess 100c minimizes the collision and interference of the wire sheath 31 with the end of the pickup plate 150 when the wire 30 is bent upward, thereby enhancing reliability and durability of contact of the connector 100.

TABLE 2

| | | |
|---|---|---|
| Type | Example | Comparison example |

| | |
|---|---|
| Push (mm) | 0.5 |

| | | |
|---|---|---|
| Force (N) | 97.27 | 87.08 |
| Plasticity (mm) | 0.2193 | 0.3148 |

As shown in table 2 above, when the end of the pickup plate of the wire insertion port is pushed to have deformation toward the upper side by a height of 0.5 mm on the assumption that the connected wire is bent by 90°, deformation is achieved by a force of 87.08 N in a pickup plate (comparison example) of a box structure without an avoidance recess, but in a pickup plate (example) of a stepped structure having an avoidance recess, the deformation by the same height is achieved when a force of 97.27 N is applied. In addition, plastic deformation according to a restoring state after deformation is applied is as follows. The comparison example shows plastic deformation of 0.3148, but the example shows plastic deformation of 0.2193.

Based on the above result, when the same external force is applied to the upper side of the wire insertion port, relatively small deformation may be made on the upper end of the connector having the avoidance recess formed thereon, in comparison to the upper end of the connector without the avoidance recess, and as a result, a relatively small external force is transmitted to the connector having the avoidance recess, and thus reliability and durability of contact of the connector can be enhanced.

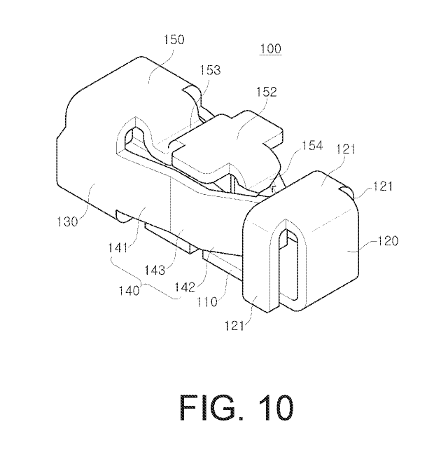

FIG. 9 is a perspective view showing an unlocking structure for the connector of the present disclosure, and FIG. 10 is a perspective view showing a connector according to another embodiment of the present disclosure.

Referring to FIG. 9, the connected wire 30 is locked into the wire connection space 100b by a sharp end of the locking portion 142, and is not easily pulled out. This is because the one pair of locking portions 142 presses both surfaces of the wire 30 with a strong elastic force. Accordingly, to pull out the wire 30, the one pair of locking portions 142 should be spaced apart from each other.

To achieve this, the present disclosure has the one pair of unlocking portions 144 formed on upper ends of the coupling portions 143 in a curved shape, and facing each other to space the locking portions 142 apart from each other. Accordingly, when the release tool 40 is inserted between the one pair of unlocking portions 144 as shown in the drawing, ends of the one pair of locking portions 142 are spaced apart from each other with the unlocking portions 144, such that the wire 30 can be easily pulled out.

In addition, when the release tool 40 is excessively inserted between the unlocking portions 144, an end of the release tool 40 presses the wire 30 and rather makes it difficult to pull out the wire 30 or damages the wire 30. Accordingly, the stopper surfaces 151, 123 are formed on ends of the pickup plates 150 and the shielding wall 121, respectively, to prevent the excessive insertion of the release tool 40 and to protect the wire 30.

In addition, in the connector 100 of the present disclosure, the unlocking portions 144 may be formed to have one pair of semicircular cross sections corresponding to each other to correspond to an exterior of the release tool 40.

Meanwhile, as shown in FIG. 10, a means for unlocking the wire 30 may be directly formed on the connector 100 without using a separate tool.

Specifically, the pickup plate 150 may have a pressing portion 152 extending from a rear end thereof, and may have an insertion protrusion 154 formed on a lower side of an end of the pressing portion 152 in a wedge shape. In addition, the pressing portion 152 is coupled to the pickup plate 150 by an elastic piece 153 forming a curved shape. When the pressing portion 152 is pressed with the wire 152 being connected to the connector 100 of the above-described configuration, the insertion protrusion 154 is inserted between the one pair of locking portions 142, and spaces the locking portions 142 apart from each other, such that the wire 30 is unlocked and is easily pulled out.

In addition, the pressing portion 152 formed on the connector 100 as described above may be formed by being extended to the front from an upper end of the blocking plate 120, and the insertion protrusion 154 may be formed on both side portions of the pressing portion 152.

Although the present disclosure has been described with reference to embodiments illustrated in the drawings, it will be understood by an ordinary person skilled in the related art that various changes can be made therefrom and other equivalent embodiments are possible.

What is claimed is:

1. A poke-in connector which has a wire connection space formed therein by bending a plate of a sheet shape in a container shape, and has a wire insertion port formed at a front thereof, the poke-in connector comprising:
a mounting plate mounted on a substrate;
a first support plate bending upward from an end of the mounting plate;
a pickup plate bending from an end of the first support plate to face the mounting plate;
a second support plate bending from an end of the pickup plate to face the first support plate, and having an end mounted on the substrate; and
connection plates bending from rear ends of the first support plate and the second support plate toward the wire insertion space, and connecting a wire inserted into the wire connection space.

2. The poke-in connector of claim 1, wherein the second support plate has a mounting terminal bending from an end thereof toward the mounting plate, and the mounting terminal is mounted on the substrate.

3. The poke-in connector of claim 1, wherein the wire insertion port has an avoidance recess, such that an end of the pickup plate is further stepped back than an end of the mounting plate.

4. The poke-in connector of claim 1, wherein the connection plates have a two-step bending structure comprising elastic portions bending from rear ends of the first support plate and the second support plate, and locking portions bending from ends of the elastic portions.

5. The poke-in connector of claim 4, wherein the elastic portion and the locking portion are coupled to each other by a coupling portion.

6. The poke-in connector of claim 1, further comprising a blocking plate bending upward from a rear end of the mounting plate to block excessive insertion of the wire.
